(19) United States
(12) Patent Application Publication
(10) Pub. No.: US 2026/0149940 A1
(43) Pub. Date: May 28, 2026

(54) EAR-WEARABLE ELECTRONIC DEVICE INCLUDING ACOUSTIC BOOT

(71) Applicant: Starkey Laboratories, Inc., Eden Prairie, MN (US)

(72) Inventors: Mark Pankratz, Bloomington, MN (US); Ganesh Borra, Minneapolis, MN (US); Eitan Cher, Denver, CO (US)

(21) Appl. No.: 19/396,878

(22) Filed: Nov. 21, 2025

Related U.S. Application Data
(60) Provisional application No. 63/725,600, filed on Nov. 27, 2024.
(60) Provisional application No. 63/725,602, filed on Nov. 27, 2024.

(51) Int. Cl. H04R 25/00; H04R 1/08

(52) U.S. Cl. CPC H04R 25/65; H04R 1/08; H04R 25/604; H04R 25/609

(57) ABSTRACT

Various embodiments of an ear-wearable electronic device that includes an acoustic boot are disclosed. The device includes an enclosure including a first housing, a second housing, and the acoustic boot disposed between the first housing and the second housing. The acoustic boot includes a body having a first major surface, a second major surface, and an outer body surface that extends between the first and second major surfaces and connects the first and second major surfaces. The acoustic boot further includes a microphone coupler connected to the body and disposed within the enclosure, and an acoustic path defined by the body, where the acoustic path extends between a first opening defined by the outer body surface and a second opening disposed within the microphone coupler and defined by a cavity of the microphone coupler.

This application claims the benefit of U.S. Provisional Application No. 63/725,600, filed Nov. 27, 2024, and U.S. Provisional Application No. 63/725,602, filed Nov. 27, 2024, the disclosures of which are incorporated by reference herein in their entireties.

### SUMMARY

In general, the present disclosure provides various embodiments of an ear-wearable electronic device that includes an enclosure having a first housing, a second housing, and an acoustic boot disposed between the first housing and the second housing. The acoustic boot includes an acoustic path defined by a body of the boot that extends between a first opening defined by an outer body surface of the body and a second opening disposed within a microphone coupler of the boot that is disposed within the enclosure, where the second opening is defined by a cavity of the microphone coupler. In one or more embodiments, the device can also include an electromechanical package that includes a microphone. Such microphone can be disposed at least partially within the cavity of the microphone coupler so that an inlet of the microphone is acoustically coupled to the acoustic path via the second opening of the path.

In one aspect, the present disclosure provides an ear-wearable electronic device that includes an enclosure including a first housing, a second housing, and an acoustic boot disposed between the first housing and the second housing. The acoustic boot includes a body having a first major surface, a second major surface, and an outer body surface that extends between the first and second major surfaces and connects the first and second major surfaces. The acoustic boot further includes a microphone coupler connected to the body and disposed within the enclosure, and an acoustic path defined by the body, where the acoustic path extends between a first opening defined by the outer body surface and a second opening disposed within the microphone coupler and defined by a cavity of the microphone coupler.

In another aspect, the present disclosure provides an acoustic boot that includes a body having a first major surface, a second major surface, and an outer body surface that extends between the first and second major surfaces and connects the first and second major surfaces. The acoustic boot further includes a microphone coupler connected to the body and configured to be disposed within an enclosure, and an acoustic path defined by the body, where the acoustic path extends between a first opening defined by the outer body surface and a second opening disposed within the microphone coupler and defined by a cavity of the microphone coupler.

In another aspect, the present disclosure provides a method of forming an ear-wearable electronic device. The method includes forming an acoustic boot, where forming the acoustic boot includes connecting a microphone coupler to a body of the acoustic boot, where the body includes a first major surface, a second major surface, and an outer body surface that extends between the first and second major surfaces and connects the first and second major surfaces. The method further includes disposing an acoustic path within the body and the microphone coupler, where the acoustic path extends between a first opening defined by the outer body surface and a second opening disposed within the microphone coupler and defined by a cavity of the microphone coupler. The method further includes disposing the acoustic boot between a first housing and a second housing to form an enclosure of the ear-wearable electronic device.

All headings provided herein are for the convenience of the reader and should not be used to limit the meaning of any text that follows the heading, unless so specified.

The terms “comprises” and variations thereof do not have a limiting meaning where these terms appear in the description and claims. Such terms will be understood to imply the inclusion of a stated step or element or group of steps or elements but not the exclusion of any other step or element or group of steps or elements.

The words “preferred” and “preferably” refer to embodiments of the disclosure that can afford certain benefits, under certain circumstances; however, other embodiments can also be preferred, under the same or other circumstances. Furthermore, the recitation of one or more preferred embodiments does not imply that other embodiments are not useful and is not intended to exclude other embodiments from the scope of the disclosure.

In this application, terms such as “a,” “an,” and “the” are not intended to refer to only a singular entity but include the general class of which a specific example can be used for illustration. The terms “a,” “an,” and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

These and other embodiments of the present disclosure will be apparent from the detailed description below. In no event, however, should the above summaries be construed as limitations on the claimed subject matter, which subject matter is defined solely by the attached claims, as can be amended during prosecution.

### BRIEF DESCRIPTION OF DRAWINGS

Throughout the specification, reference is made to the appended drawings, where like reference numerals designate like elements, and wherein:

FIG. 1 is a schematic side view of one embodiment of an ear-wearable electronic device that includes an acoustic boot.

FIG. 2 is a schematic cross-section view of the device of FIG. 1 with an electromechanical package and the acoustic boot removed for clarity.

FIG. 3 is a schematic front perspective view of the acoustic boot of FIG. 1.

FIG. 4 is a schematic rear view of the acoustic boot of FIG. 1.

FIG. 5 is a schematic front view of the acoustic boot of FIG. 1.

FIG. 6 is a schematic rear view of the acoustic boot of FIG. 1.

FIG. 7 is a schematic top plan view of the acoustic boot of FIG. 1.

FIG. 8 is a schematic bottom plan view of the acoustic boot of FIG. 1.

FIG. 9 is a schematic cross-section view of the acoustic boot of FIG. 1.

FIG. 10 is a schematic perspective view of the acoustic boot of FIG. 1 and the electromechanical package of the ear-wearable device of FIG. 1 that includes a microphone disposed at least partially within a cavity of a microphone coupler of the acoustic boot.

FIG. 11 is a block diagram of the ear-wearable electronic device of FIG. 1.

FIG. 12 is a flow chart of one embodiment of a method of forming the ear-wearable electronic device of FIG. 1.

### DETAILED DESCRIPTION

In general, the present disclosure provides various embodiments of an ear-wearable electronic device that includes an enclosure having a first housing, a second housing, and an acoustic boot disposed between the first housing and the second housing. The acoustic boot includes an acoustic path defined by a body of the boot that extends between a first opening defined by an outer body surface of the body and a second opening disposed within a microphone coupler of the boot that is disposed within the enclosure, where the second opening is defined by a cavity of the microphone coupler. In one or more embodiments, the device can also include an electromechanical package that includes a microphone. Such microphone can be disposed at least partially within the cavity of the microphone coupler so that an inlet of the microphone is acoustically coupled to the acoustic path via the second opening of the path.

Ear-wearable electronic devices such as hearing devices can include an acoustic path that can be formed by two or more parts. Such configurations can, however, include imperfect connections between parts that produce unrepeatable and unreliable acoustic path geometries of two or more devices, even though such devices are manufactured utilizing the same process. Variations in acoustic path geometries between similar devices can create differences in acoustic characteristics of the acoustic paths. As a result, it can be preferable to remove or reduce these acoustic path geometrical irregularities to improve sound quality performance across similar devices.

Further, the acoustic path of an ear-wearable electronic device that is formed by two or more parts can be expensive to repair or replace. As a result, it can be preferable to replace a single part to fix the damaged or occluded acoustic path without having to remove and replace multiple parts. The acoustic path of an ear-wearable electronic device that is formed by two or more parts can also require a gasket to seal the parts together to provide a sealed acoustic path. It can, therefore, be preferable to produce a sealed acoustic path that does not require a gasket.

One or more embodiments of an ear-wearable electronic device described herein can provide various advantages over currently available devices. For example, one or more embodiments of devices described herein can include an acoustic boot that is a unitary design and defines the acoustic path. This unitary design can provide a repeatable and reliable acoustic path geometry between devices that are manufactured using the same or similar manufacturing processes that can improve sound quality performance of the device.

Further, one or more embodiments of an ear-wearable electronic device described herein can facilitate more efficient and cost-effective field replacement services. For example, a single-piece acoustic boot of the device can be utilized to replace a damaged or occluded acoustic path. In contrast, replacement of a damaged or occluded acoustic path that is formed by two or more parts can be far more costly and time-consuming to replace.

The unitary acoustic boot of one or more embodiments of devices described herein can also provide a sealed acoustic path, thereby eliminating the need for one or more gaskets to be disposed between connected parts of the acoustic path of currently available designs.

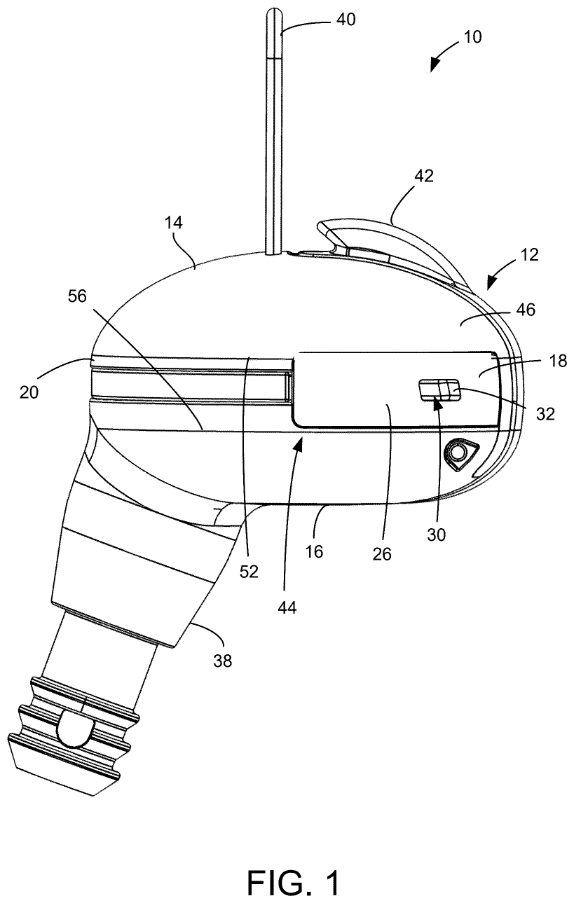

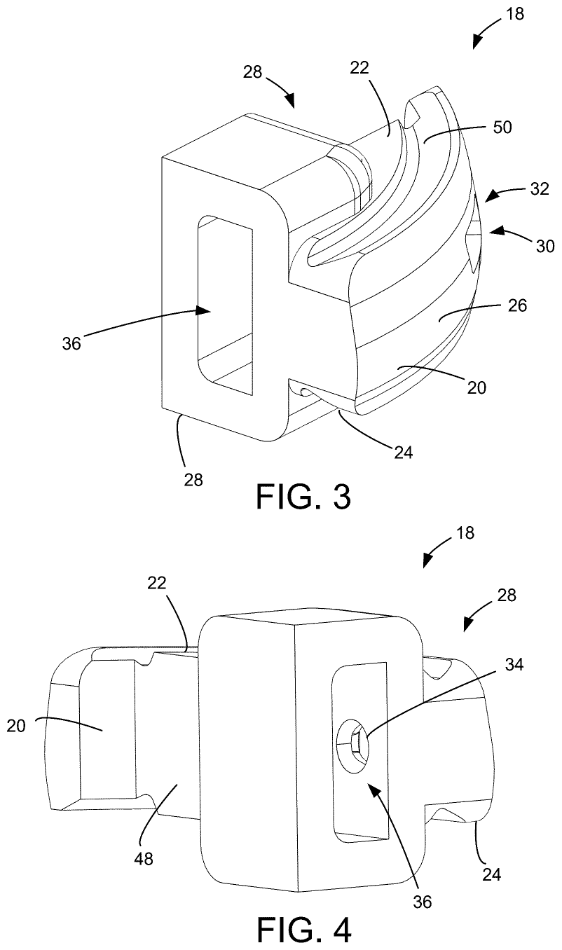

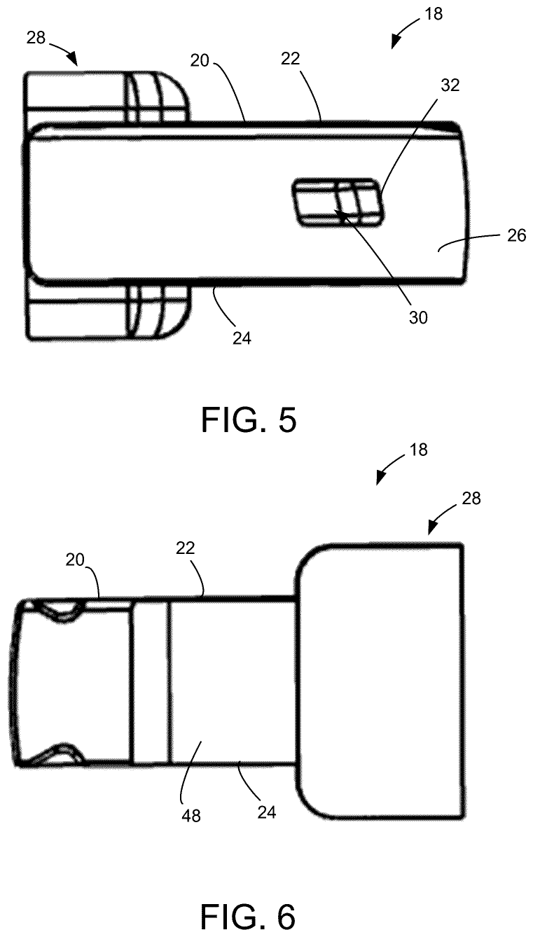

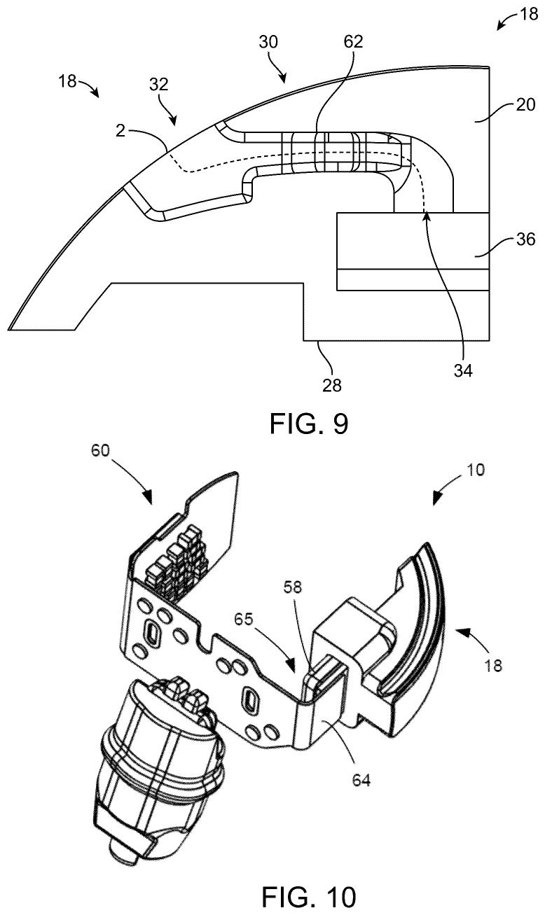

FIG. 1 is a schematic side view of one embodiment of an ear-wearable electronic device 10. The device 10 includes an enclosure 12 that has a first housing 14, a second housing 16, and an acoustic boot 18 disposed between the first housing and the second housing. As shown in FIGS. 3-10, the acoustic boot 18 includes a body 20 having a first major surface 22, a second major surface 24, and an outer body surface 26 that extends between the first and second major surfaces and connects the first and second major surfaces. The acoustic boot 18 also includes a microphone coupler 28 connected to the body 20 and disposed within the enclosure 12 (FIG. 1). The acoustic boot 18 can also include an acoustic path 30 (FIG. 9) defined by the body 20, where the acoustic path extends between a first opening 32 defined by the outer body surface 26 and a second opening 34 disposed within the microphone coupler 28 and defined by a cavity 36 of the microphone coupler.

The ear-wearable electronic device 10 can include any suitable device or devices. For example, the ear-wearable electronic device 10 can be a hearing assistance device. Any suitable hearing assistance device can be utilized, e.g., behind-the-ear (BTE), in-the-ear (ITE), in-the-canal (ITC), receiver-in-canal (RIC), completely-in-the-canal (CIC), or invisible-in-the-canal (IIC)-type hearing aids. It is understood that BTE type hearing assistance devices can include devices that reside substantially behind the ear or over the ear. Such devices can include hearing aids with receivers associated with the electronics portion of the device or hearing aids of the type having receivers in the ear canal of the user, including but not limited to receiver-in-canal (RIC) or receiver-in-the-ear (RITE) designs. The present subject matter can also be used in hearing assistance devices generally, such as cochlear implant type hearing devices and such as deep insertion devices having a transducer, such as a receiver or microphone, whether custom fitted, standard, open fitted, or occlusive fitted. The present subject matter can additionally be used in consumer electronic wearable audio devices having various functionalities. It is understood that other devices not expressly stated herein can also be used with the present subject matter.

The device 10 can take any suitable shape have any suitable design such that at least a portion of the enclosure 12 fits within a wearer's ear. The device 10 can include any suitable components such as one or more of a port, spout 38, antenna, handle 40, cover, or any other features suitable for assisting in the performance or function of the device. The device 10 can include any number of such components connected to or integral with the enclosure 12 (e.g., two antennas, three spouts, etc.). These components can be disposed in any suitable location or arrangement for assisting in the performance or function of the device 10.

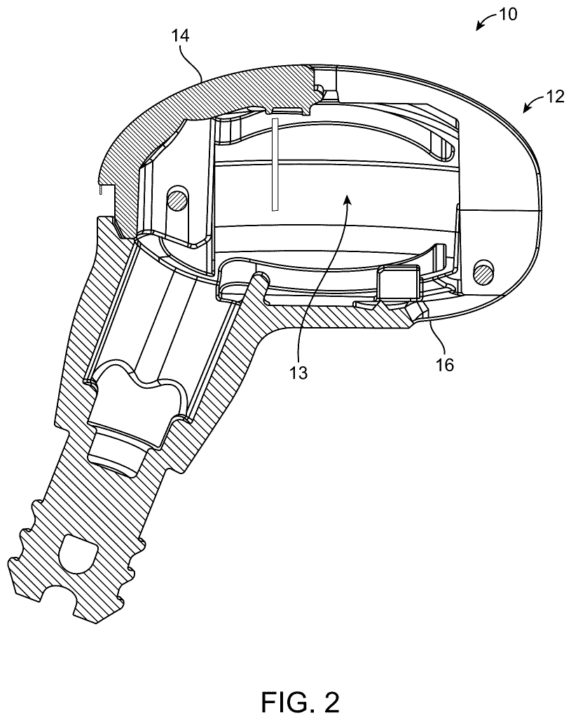

The enclosure 12 can take any suitable shape and have any suitable dimensions such that at least a portion of the enclosure fits within an ear of a wearer. The enclosure 12 can define an interior volume 13 as shown in FIG. 2, which is a schematic cross-section view of the device 10 with an electromechanical package 60 and the acoustic boot 18 of the device removed for clarity. Further, the enclosure 12 can include any suitable material, e.g., at least one of an inorganic material (e.g., metallic or ceramic material) or polymeric material (e.g., a thermoplastic or thermoset material).

The first housing 14 and the second housing 16 of the enclosure 12 can each take any suitable shape and have any suitable dimensions. Each of the first and second housings 14, 16 defines a portion of the enclosure 12. Further, the first and second housing 14, 16 can include any suitable materials, e.g., at least one of the materials described herein regarding the enclosure 12. The first and second housing 14, 16 can include the same materials. In one or more embodiments, the first housing 14 includes a material that is different from a material of the second housing 16. The first and second housings 14, 16 can be manufactured utilizing the same technique or different techniques.

The first housing 14 and the second housing 16 can be connected using any suitable technique to form the enclosure 12. Examples of suitable techniques can include at least one of mechanical fastening, friction fitting, welding, molding, or adhesively connecting. In one or more embodiments, the first housing 14 can be integral with the second housing 16, i.e., manufactured as a single component, using any suitable technique.

In one or more embodiments, the device 10 can include an enclosure opening 44 (FIG. 1) defined by the first housing 14 and the second housing 16. The acoustic boot 18 can be at least partially disposed within the enclosure opening 44 so that the outer body surface 26 of the acoustic boot 18 and the surfaces of the first housing 14 and second housing 16 are flush to form an outer surface 46 of the enclosure 12.

Disposed between the first housing 14 and the second housing 16 is the acoustic boot 18. As used herein, the term “between the first housing and the second housing” means that at least a substantial portion of the acoustic boot 18 is disposed within the interior volume 13 of the enclosure 12 formed by the first and second housing 14, 16. In one or more embodiments, the acoustic boot 18 is disposed entirely within this interior volume of the enclosure 12 with the exception of the outer body surface 26 of the acoustic boot.

The acoustic boot 18 can take any suitable shape and have any suitable dimensions. Further, the acoustic boot 18 can include any suitable material. Examples of suitable materials include conductive metals, non-conductive metals, polymers, ceramics, glass, composites, or any combination of two or more of such materials. Examples of polymer materials include thermoplastic elastomers, thermoplastic polyurethane, thermoplastic copolyester, thermoplastic polyamide, thermoset elastomers (e.g., silicone) or any combination of two or more of such materials. The acoustic boot 18 can be formed by any suitable manufacturing process. Examples of manufacturing processes include 3D printing, extruding, or injection molding, compression molding, casting, etc. The acoustic boot 18 can be a unitary component or two or more portions that are connected together using any suitable technique.

FIGS. 3-10 are various views of the acoustic boot 18 of FIG. 1. The body 20 of the acoustic boot 18 includes the first major surface 22, the second major surface 24, and the outer body surface 26 that extends between the first and second major surfaces and connects the first and second major surfaces. The first major surface 22 and the second major surface 24 can each take any suitable shape and have any suitable dimensions. In one or more embodiments, at least one of the first major surface 22 and the second major surface 24 takes a substantially planar shape. In one or more embodiments, each of the first and second major surfaces 22, 24 takes a planar shape, and the first major surface is substantially parallel to the second major surface.

The outer body surface 26 of the acoustic boot 18 can also take any suitable shape and have any suitable dimensions. In one or more embodiments, the outer body surface 26 takes a substantially curved shape in a plane substantially parallel to the first and second major surfaces 22, 24 of the body 20. In one or more embodiments, the outer body surface 26 takes the same shape as a shape of each of the first and second housings 14, 16 of the enclosure 12 adjacent the outer body surface in the plane substantially parallel to the first and second major surfaces 22, 24 of the body 20 so that the outer body surface is flush with the first and second housings in such plane. In one or more embodiments, the first major surface 22 and the second major surface 24 are substantially orthogonal to the outer body surface 26 of the acoustic boot 18.

The body 20 of the acoustic boot 18 also includes an inner body surface 48 (FIGS. 4 and 6) that extends between the first major surface 22 and the second major surface 24 of the body and connects the first and second major surfaces. The inner body surface 48 can take any suitable shape and have any suitable dimensions. In one or more embodiments, the inner body surface 48 is disposed entirely within the enclosure 12. In one or more embodiments, the inner body surface 48 can be substantially orthogonal to the first major surface 22 and the second major surface 24.

In one or more embodiments, at least one of the first housing 14 or second housing 16 can be connected to the acoustic boot 18. In one or more embodiments, the first major surface 22 of the body 20 is connected to the first housing 14 and the second major surface 24 of the body is connected to the second housing 16. In one or more embodiments, the first housing 14 is connected to the acoustic boot 18 and the second housing 16 using any suitable technique. In one or more embodiments, the first housing 14 is adhesively connected to at least one of the acoustic boot 18 or the second housing 16. In one or more embodiments, the second housing 16 is connected to the acoustic boot 18.

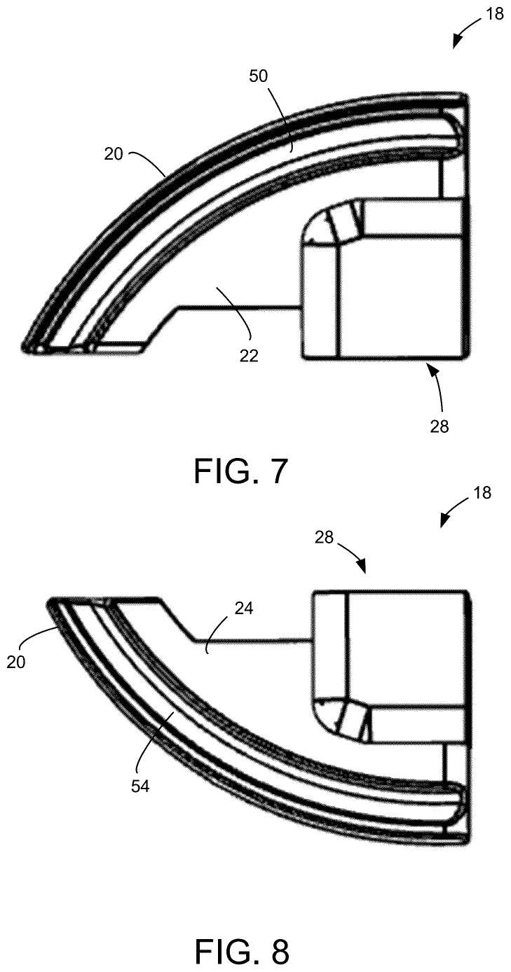

The acoustic boot 18 can be connected to at least one of the first or second housings 14, 16 using any suitable technique, e.g., at least one of mechanical fastening, friction fitting, welding, molding, adhesively connecting, etc. In one or more embodiments, the acoustic boot 18 and the first housing 14 can be connected by a first lap joint 50 (FIG. 7) disposed in the first major surface 22 of the body 20. The first lap joint 50 can take any suitable shape and have any suitable dimensions. The first lap joint 50 can be configured to receive a portion or portions of an edge surface 52 (FIG. 1) of the first housing 14 so that the first housing is connected to the acoustic boot 18 (e.g., friction fitting, adhesively connecting, etc.). Further, the acoustic boot 18 and the second housing 16 can be connected by a second lap joint 54 (FIG. 8) disposed in the second major surface 24 of the body 20 (e.g., friction fitting, adhesively connecting, etc.). The second lap joint 54 can take any suitable shape and have any suitable dimensions. The second lap joint 54 can be configured to receive a portion or portions of an edge surface 56 (FIG. 1) of the second housing 16 so the second housing is connected to the acoustic boot 18 (e.g., friction fitting, adhesively connecting, etc.).

The acoustic boot 18 further includes the microphone coupler 28 that is connected to the body 20 of the boot. The microphone coupler 28 can take any suitable shape and have any suitable dimensions. Further, the microphone coupler 28 can be connected to any suitable portion of the body 20 of the acoustic boot 18. In one or more embodiments, the microphone coupler 28 can be connected to the body 20 so that the coupler is disposed within the enclosure 12. For example, the microphone coupler 28 can be connected to the inner body surface 48 of the body 20 as shown in FIG. 4.

The microphone coupler 28 can be connected to the body 20 of the acoustic boot 18 using any suitable technique. Examples of suitable techniques include at least one of mechanical fastening, friction fitting, welding, molding, adhesively connecting, etc. In one or more embodiments, the microphone coupler 28 can be integral with the body 20 of the acoustic boot 18.

The microphone coupler 28 includes the cavity 36. The cavity 36 can take any suitable shape and have any suitable dimensions. In one or more embodiments, the cavity 36 is configured to receive at least a portion of a microphone 58 (FIG. 10) of an electromechanical package 60 that is disposed at least partially within the enclosure 12. As is further described herein, the cavity 36 can also be configured to receive at least a portion of the microphone 58 and a portion of a flexible circuit board assembly (PCBA) 62 upon which the microphone can be disposed (FIG. 10). The microphone 58 can be disposed at least partially within the cavity 36 of the microphone coupler 28 using any suitable technique. In one or more embodiments, the microphone 58 can be friction fit at least partially within the cavity 36 of the microphone coupler 28.

The acoustic boot body 20 further includes the acoustic path 30 (FIG. 9). In one or more embodiments, the acoustic path 30 is defined by the body 20 of the acoustic boot 18. The acoustic path 30 extends between the first opening 32 defined by the outer body surface 26 of the body 20 and the second opening 34 that is disposed within the microphone coupler 28 and defined by the cavity 36 of the microphone coupler. Although depicted as including first and second openings, 32, 34, the acoustic path 30 can include any suitable number of openings. The acoustic path 30 can extend along an axis 2 between the first opening 32 and the second opening 34. The axis 2 is defined as an axis that intersects a geometrical center of each cross-sectional plane along the acoustic path 30.

In general, the acoustic path 30 can take any suitable shape. For example, the acoustic path 30 can be a tortuous path that includes multiple changes in direction relative to an initial direction of the path at either the first opening 32 or the second opening 34 of the path. In one or more embodiments, the acoustic path 30 can be straight and not include any direction changes. In one or more embodiments, the acoustic path 30 can include any other suitable direction changes for assisting in the performance or function of the hearing device 10.

The acoustic path 30 acoustically couples the first opening 32 and the second opening 34. As used herein, the term “acoustically coupled” means fluidically coupled or that any barrier disposed between two or more elements or components that are acoustically coupled is generally acoustically transparent for frequencies of interest, where acoustically transparent means that the element or component attenuates sound at a sound pressure level of no greater than 6 dB.

As mentioned herein, the acoustic path 30 can take any suitable shape. For example, the acoustic path 30 can take any cross-sectional shape in a plane substantially orthogonal to the axis 2. As shown in FIG. 9, at least a middle portion 62 of the acoustic path 30 includes a rectangular shape in a cross-sectional plane that is substantially orthogonal to the axis 2. The acoustic path 30 can take the same cross-sectional shape along the axis 2. In one or more embodiments, the cross-sectional shape of the acoustic path 30 can vary along the axis 2. Additional suitable cross-sectional shapes include elliptical, triangular, polygonal, or faceted shapes.

In one or more embodiments, one or more traps (not shown) can be connected to the acoustic path 30 that are configured to retain debris. Any suitable trap or traps can be connected to the acoustic path 30, e.g., one or more embodiments of traps described in co-filed U.S. Patent Application No. 63/725,602 (Atty Docket No. ST1089PRV), entitled EAR-WEARABLE ELECTRONIC DEVICE INCLUDING DEBRIS TRAP. Any suitable number of traps can be connected to the acoustic path. Further, the traps can be disposed in any suitable portion of the path 30 in or along the acoustic path. For example, one or more traps can be disposed on or connected to the acoustic path 30 adjacent at least one of the first opening 32 or the second opening 34. In one or more embodiments, one or more traps can be disposed or connected to the middle portion 62 of the acoustic path 30.

Although not shown, the acoustic path 30 can include one or more mesh screens. The mesh screens can be configured to retain debris (e.g., earwax, keratin, hair follicles, etc.). The mesh screens can include any suitable material. Further, the mesh screens can be disposed at any suitable location over or at least partially within the acoustic path 30, e.g., adjacent at least one of the first opening 32, the second opening 34, or the middle portion 62 of the path.

Any suitable component or components can be acoustically coupled to the acoustic path 30. For example, FIG. 10 is a schematic perspective view of the electromechanical package 60 and the acoustic boot 18 of the device 10. The electromechanical package 60 can be disposed at least partially within the interior volume 13 of the enclosure 12. In one or more embodiments, the package 60 can be disposed entirely within the enclosure 12. The electromechanical package 60 can include any suitable components or circuitry. Examples of suitable components or circuitry include flexible circuit board assemblies (PCBA), batteries, microphones, cameras, receivers, radios, one or more sensors, such as a motion detector, a microphone, a heart rate sensor, or an electrophysiological sensor, or any circuitry or components suitable for assisting in the performance or function of hearing devices.

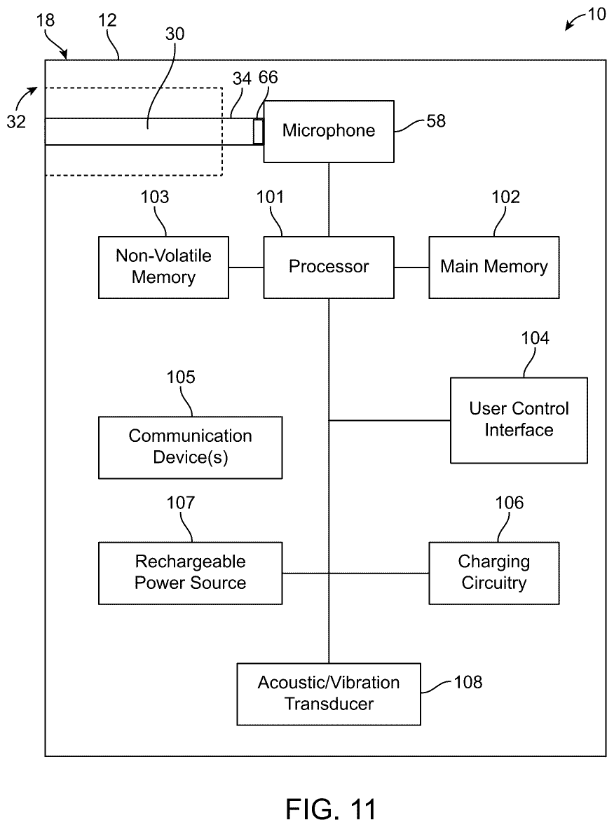

AS shown in FIG. 10, the electromechanical package includes a PCBA 64 and the microphone 58 disposed on or at least partially in the PCBA. The PCBA 64 can include any suitable layer or layers. As used herein the term “PCBA” refers to a laminated, flexible sandwich structure that can include conductive layers, insulating layers, and vias allowing for interconnections between layers. The PCBA 64 can support and/or be coupled to various electronic components (e.g., integrated circuits, processors, memories), electrical circuitry (passive and active electrical components), one or more sensors, and/or one or more transducers (e.g., the microphone 58, a receiver, etc.) as is further described herein in reference to FIG. 11.

The microphone 58 can include any suitable microphone or microphone array, e.g., a MEMS microphone, an electret condenser microphone, co-joined microphone sets, etc. The microphone 58 can be electrically connected to the PCBA 64 using any suitable technique, e.g., one or more of the techniques described in U.S. Patent Publication No. 2023/0336928 A1. The device 10 can include any suitable number of microphones.

The microphone 58 can be configured to convert acoustic waves that enter the microphone through the acoustic path 30 and a microphone inlet 66 (FIG. 11) into one or more electric signals that are directed to a controller or processor (e.g., processor 101 of FIG. 11) of the electromechanical package 60 that is disposed within the enclosure 12 or remotely from the enclosure by a wired or wireless connection.

The microphone 58 can be disposed at least partially in the cavity 36 of the microphone coupler 28. In one or more embodiments, the microphone 58 is disposed completely or entirely within the cavity 36. In one or more embodiments, the microphone 58 and at least the portion 65 of the PCBA 64 upon which the microphone is disposed can be disposed at least partially within the cavity 36. In this configuration, the microphone inlet 66 of the microphone 58 can be acoustically coupled to the acoustic path 30 via the second opening 34 of the path (FIG. 11). Any suitable technique can be utilized to acoustically couple the microphone 58 to the acoustic path 30.

At least one of the microphone 58 or the portion 65 of the PCBA 64 can be connected to the acoustic boot 18 using any suitable technique. In one or more embodiments, at least one of the microphone 58 or the portion 65 of the PCBA 64 can be friction fit within the cavity 36 of the microphone coupler 28. In one or more embodiments, the microphone 58 and the portion 65 of the PCBA can be adhered, mechanically fastened, or bonded to the microphone coupler 28.

The device 10 can include any additional elements or components. For example, the device 10 can include a handle 40 that is configured to relay signals to and from components or circuitry of the device and assist the wearer in grasping the device. The handle 40 can be disposed on any suitable portion or portions of the enclosure 12 or within the enclosure. Further, the handle 40 can take any suitable shape and have any suitable dimensions.

In one or more embodiments, the device 10 can include a battery cover 42 configured to allow access to a battery (not shown) within the device. The battery cover 42 can be disposed on or at least partially within any suitable portion or portions of the enclosure 12. Further, the battery cover 42 can take any suitable shape and have any suitable dimensions.

As shown in FIG. 1, the device 10 can also include a spout 38 that is configured to receive an earbud and be placed at least partially within the wearer's ear canal. The spout 38 can be integral with the second housing 16 or manufactured separately and connected to the second housing using any suitable technique. In one or more embodiments, the spout 38 can form a portion of the enclosure.

The various embodiments of ear-wearable electronic devices described herein can include any suitable electronic components or circuitry. For example, FIG. 11 is a block diagram that illustrates various electronic components and circuitry of the device 10. The illustrated components and circuitry can be disposed on or connected to the electromechanical package 60 or disposed on or within the enclosure 12 separate from the package.

The device 10 includes a processor 101 operatively coupled to a main memory 102 and a non-volatile memory 103. The processor 101 can be implemented as one or more of a multi-core processor, a digital signal processor (DSP), a microprocessor, a programmable controller, a general-purpose computer, a special-purpose computer, a hardware controller, a software controller, a combined hardware and software device, such as a programmable logic controller, and a programmable logic device. The processor 101 can include or be operatively coupled to main memory 102. The processor 101 can include or be operatively coupled to non-volatile memory 103.

In one or more embodiments, the device 10 includes an audio processing facility operably coupled to, or incorporating, the processor 101. The audio processing facility includes audio signal processing circuitry (e.g., analog front-end, analog-to-digital converter, digital-to-analog converter, DSP, and various analog and digital filters), the microphone 58, and an acoustic/vibration transducer 108 (e.g., loudspeaker, receiver, bone conduction transducer, motor actuator). In one or more embodiments, the transducer 108 is one or more MEMS receivers. Each of the microphone 58 and transducer 108 can be disposed on or at least partially in the PCBA 64 disposed within the device 10. The acoustic transducer 108 can be configured to produce amplified sound inside the ear canal.

The microphone 58 can include one or more discrete microphones or a microphone array. Each of the microphones 58 can be situated at different locations of the device 10. It is understood that the term microphone used herein can refer to a single microphone or multiple microphones unless specified otherwise. The microphone 58 is operatively coupled to the processor 101 and is configured to direct a microphone signal to the processor, which in turn directs a receiver signal to the transducer 108 that is based at least in part on the microphone signal.

The device 10 also includes the acoustic boot 18 having the body 20 that defines the acoustic path 30 that extends between the first opening 32 defined by the outer body surface 26 of acoustic boot and the second opening 34 disposed within the 28, where the second opening is defined by the cavity 36 of the microphone coupler. The acoustic path 30 is acoustically coupled to the inlet 66 of the microphone 58 via the second opening 34 of the acoustic path.

In one or more embodiments, the device 10 can also include a user control interface 104 operatively coupled to the processor 101. The user control interface 104 is configured to receive an input from the wearer of the device 10. The input from the wearer can be any type of user input, such as a touch input, a gesture input, or a voice input.

The device 10 can also include one or more communication devices 105. For example, the one or more communication devices 105 can include one or more radios coupled to one or more antenna arrangements that conform to an IEEE 802.13 (e.g., Wi-Fi®) or Bluetooth® (e.g., BLE, Bluetooth® 4.2, 5.0, 5.1, 5.2 or later) specification, for example. In addition, or alternatively, the device 10 can include a near-field magnetic induction (NFMI) sensor (e.g., an NFMI transceiver coupled to a magnetic antenna) for effecting short-range communications (e.g., ear-to-ear communications, ear-to-kiosk communications). The communications device 105 can also include wired communications, e.g., universal serial bus (USB) and the like. Further, the communication devices 105 can include a flexible antenna disposed on or at least partially within the PCBA disposed within the device 10.

The device 10 also includes a power source 107, which can be a conventional battery, a rechargeable battery (e.g., a lithium-ion battery), or a power source including a supercapacitor. In the embodiment shown in FIG. 11, the power source 107 includes a rechargeable power source that is operably coupled to power management circuitry for supplying power to various components of the device 10. The rechargeable power source 107 is coupled to charging circuity 106.

The device 10 can further include any other suitable electronic elements or components. Although not shown, the device 10 can include one or more inertial measurement units (IMUs) disposed within the device. In one or more embodiments, such IMUs can be disposed on or at least partially within the PCBA 64 that is disposed within the device.

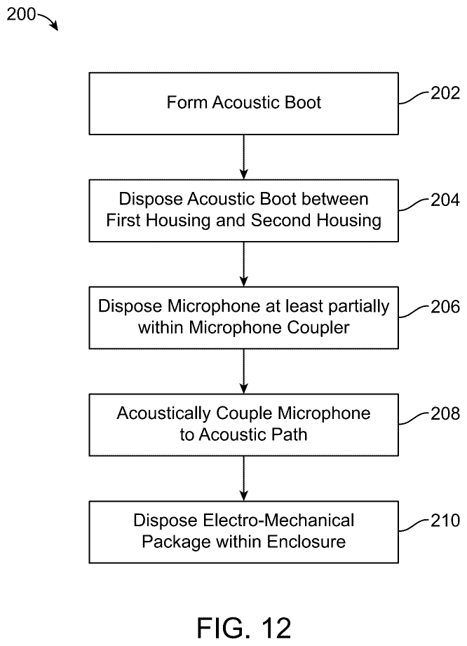

The ear-wearable electronic device 10 of FIGS. 1-11 can be manufactured using any suitable technique. For example, FIG. 12 is a flowchart of one embodiment of a technique 200 for manufacturing the ear-wearable electronic device 10. Although described in reference to ear-wearable electronic device 10 of FIGS. 1-11, the technique 200 can be utilized to manufacture any suitable ear-wearable electronic device. At 202, the acoustic boot 18 can be formed using any suitable technique. For example, the microphone coupler 28 can be connected to the body 20 of the acoustic boot 18 using any suitable technique. In one or more embodiments, the microphone coupler 28 can be connected to the body 20 by molding the microphone coupler to the body so that the microphone coupler is integral with the body.

Further, the acoustic path 30 can be disposed within the body 20 and the microphone coupler 28 using any suitable technique. At 204, the acoustic boot 18 can be disposed between the first housing 14 and the second housing 16 to form the enclosure 12 of the device 10 using any suitable technique. In one or more embodiments, the first housing 14 can be connected to the acoustic boot 18 and the second housing 16. In one or more embodiments, the second housing 16 can be connected to the acoustic boot 18. In one or more embodiments, the first housing 14 can be adhesively connected to the acoustic boot 18 and the second housing 16. In one or more embodiments, the acoustic boot 18, first housing 14 and second housing 16 can be connected using lap joints 50, 54 as is further described herein. In one or more embodiments, the acoustic boot 18 can be disposed between the first housing 14 and the second housing 16 by disposing the acoustic boot at least partially within the enclosure opening 44 defined by the first housing and second housing.

At 206, the microphone 58 can optionally be disposed at least partially within the microphone coupler 28 using any suitable technique. In one or more embodiments, the microphone 58 can be disposed at least partially within the cavity 36 of the microphone coupler 28 prior to disposing the acoustic boot 18 between the first housing 14 and the second housing 16, where the microphone is disposed within the enclosure 12 when the acoustic boot is disposed between the first and second housings. Further, the inlet 66 of the microphone 58 can optionally be coupled to the acoustic path 30 via the second opening 34 of the acoustic path at 208 using any suitable technique.

At 210, the electromechanical package 60 can optionally be disposed within the enclosure 12 using any suitable technique. The microphone 58 can be disposed at least partially within the cavity 36 of the microphone coupler 28 when the electromechanical package 60 is disposed within the enclosure 12. Prior to disposing the microphone 58 at least partially within the cavity 36, the microphone can be disposed on the portion 65 of the PCBA using any suitable technique.

Embodiments of the disclosure are defined in the claims; however, herein there is provided a non-exhaustive listing of non-limiting examples. Any one or more of the features of these examples can be combined with any one or more features of another example, embodiment, or aspect described herein.

Example Ex1. An ear-wearable electronic device including an enclosure having a first housing, a second housing, and an acoustic boot disposed between the first housing and the second housing. The acoustic boot includes a body including a first major surface, a second major surface, and an outer body surface that extends between the first and second major surfaces and connects the first and second major surfaces. The acoustic boot further includes a microphone coupler connected to the body and disposed within the enclosure, and an acoustic path defined by the body and that extends between a first opening defined by the outer body surface and a second opening disposed within the microphone coupler and defined by a cavity of the microphone coupler.

Example Ex2. The device of Ex1, further including an electromechanical package including a microphone disposed at least partially within the cavity of the microphone coupler.

Example Ex3. The device of Ex2, where the microphone is friction fit at least partially within the cavity of the microphone coupler.

Example Ex4. The device of any one of Ex2-Ex3, where the acoustic path is acoustically coupled to an inlet of the microphone via the second opening.

Example Ex5. The device of any one of Ex2-Ex4, where the electromechanical package further includes a flexible printed circuit board assembly (PCBA) disposed within the enclosure, where the microphone is disposed on the PCBA.

Example Ex6. The device of any one of Ex5, where a portion of the PCBA and is disposed within the cavity of the microphone coupler.

Example Ex7. The device of any one of Ex1-Ex6, where the acoustic path extends along an axis between the first opening and the second opening.

Example Ex8. The device of Ex7, where the acoustic path includes a rectangular shape in a cross-sectional plane that is substantially orthogonal to the axis.

Example Ex9. The device of any one of Ex1-Ex8, where the first major surface of the body is substantially parallel to the second major surface of the body.

Example Ex10. The device of any one of Ex1-Ex9, where the first major surface of the body is connected to the first housing and the second major surface of the body is connected to the second housing.

Example Ex11. The device of any one of Ex1-Ex10, where the body further includes an inner body surface that extends between the first major surface and the second major surface and connects the first and second major surfaces.

Example Ex12. The device of Ex11, where the microphone coupler is connected to the inner body surface of the body.

Example Ex13. The device of any one of Ex1-Ex12, where the microphone coupler is integral with the body.

Example Ex14. The device of any one of Ex1-Ex13, where the first housing is connected to the acoustic boot and the second housing.

Example Ex15. The device of Ex14, where the first housing is adhesively connected to at least one of the acoustic boot or the second housing.

Example Ex16. The device of any one of Ex1-Ex15, where the second housing is connected to the acoustic boot.

Example Ex17. The device of Ex16, where the second housing is adhesively connected to the acoustic boot.

Example Ex18. The device of any one of Ex1-Ex17, where the device further includes an enclosure opening defined by the first housing and the second housing.

Example Ex19. The device of Ex18, where the acoustic boot is at least partially disposed within the enclosure opening.

Example Ex20. The device of any one of Ex1-Ex19, where the acoustic boot and the first housing are connected by a first lap joint disposed in the first major surface of the body.

Example Ex21. The device of Ex20, where the acoustic boot and the second housing are connected by a second lap joint disposed in the second major surface of the body.

Example Ex22. The device of any one of Ex1-Ex21, where the acoustic boot includes an elastomeric material.

Example Ex23. An acoustic boot, including a body including a first major surface, a second major surface, and an outer body surface that extends between the first and second major surfaces and connects the first and second major surfaces. The acoustic boot further including a microphone coupler connected to the body and disposed and configured to be disposed within an enclosure, and an acoustic path defined by the body and that extends between a first opening defined by the outer body surface and a second opening disposed within the microphone coupler and defined by a cavity of the microphone coupler.

Example Ex24. The acoustic boot of Ex23, where the acoustic path extends along an axis between the first opening and the second opening.

Example Ex25. The acoustic boot of Ex24, where the acoustic path includes a rectangular shape in a cross-sectional plane that is substantially orthogonal to the axis.

Example Ex26. The acoustic boot of any one of Ex23-Ex25, where the first major surface of the body is substantially parallel to the second major surface of the body.

Example Ex27. The acoustic boot of any one of Ex23-Ex26, where the body further includes an inner body surface that extends between the first major surface and the second major surface and connects the first and second major surfaces.

Example Ex28. The acoustic boot of Ex27, where the microphone coupler is connected to the inner body surface of the body.

Example Ex29. The acoustic boot of any one of Ex23-Ex28 where the microphone coupler is integral with the body.

Example Ex30. The acoustic boot of any one of Ex23-Ex29, where the acoustic boot includes an elastomeric material.

Example Ex31. A method of forming an ear-wearable electronic device including forming an acoustic boot. Where forming the acoustic boot includes connecting a microphone coupler to a body of the acoustic boot. The body includes a first major surface, a second major surface, and an outer body surface that extends between the first and second major surfaces and connects the first and second major surfaces. The method further includes disposing an acoustic path within the body and the microphone coupler, where the acoustic path extends between a first opening defined by the outer body surface and a second opening disposed within the microphone coupler. The method further includes disposing the acoustic boot between a first housing and a second housing to form an enclosure of the ear-wearable electronic device.

Example Ex32. The method of Ex31, further including disposing a microphone at least partially within the cavity of the microphone coupler prior to disposing the acoustic boot between the first housing and the second housing, where the microphone is disposed within the enclosure when the acoustic boot is disposed between the first and second housings.

Example Ex33. The method of Ex32, further including acoustically coupling an inlet of the microphone to the acoustic path via the second opening.

Example Ex34. The method of any one of Ex32-Ex33, further including disposing an electromechanical package within the enclosure, where the package includes the microphone and a flexible printed circuit board assembly (PCBA).

Example Ex35. The method of Ex34, further including disposing the microphone on a portion of the PCBA prior to disposing the microphone at least partially within the cavity of the microphone coupler.

Example Ex36. The method of any one of Ex31-Ex35, further including connecting the first housing to the acoustic boot and the second housing.

Example Ex37. The method of Ex36, further including connecting the second housing to the acoustic boot.

Example Ex38 The method of any one of Ex36-Ex37, where connecting the first housing to the acoustic boot and the second housing includes adhesively connecting the first housing to the acoustic boot and the second housing.

Example Ex39. The method of any one of Ex31-Ex38, where disposing the acoustic boot between the first housing and the second housing includes disposing the acoustic boot at least partially within an enclosure opening defined by the first housing and second housing.

Example Ex40. The method of any one of Ex31-Ex39, where forming the acoustic boot further includes forming a first lap joint in the first major surface of the body and forming a second lap joint in the second major surface of the body, where disposing the acoustic boot between the first housing and the second housing includes disposing an edge portion of the first housing into the first lap joint and disposing an edge portion of the second housing into the second lap joint.

Example Ex41. The method of any one of Ex31-Ex40, where connecting the microphone coupler to the body includes molding the microphone coupler to the body so that the microphone coupler is integral with the body.

1. An ear-wearable electronic device, comprising:
an enclosure comprising a first housing, a second housing, and an acoustic boot disposed between the first housing and the second housing, wherein the acoustic boot comprises:
a body comprising a first major surface, a second major surface, and an outer body surface that extends between the first and second major surfaces and connects the first and second major surfaces;
a microphone coupler connected to the body and disposed within the enclosure; and
an acoustic path defined by the body and that extends between a first opening defined by the outer body surface and a second opening disposed within the microphone coupler and defined by a cavity of the microphone coupler.

2. The device of claim 1, further comprising an electromechanical package comprising a microphone disposed at least partially within the cavity of the microphone coupler.

3. The device of claim 2, wherein the acoustic path is acoustically coupled to an inlet of the microphone via the second opening.

4. The device of claim 2, wherein the electromechanical package further comprises a flexible printed circuit board assembly (PCBA) disposed within the enclosure, wherein the microphone is disposed on the PCBA.

5. The device of claim 4, wherein a portion of the PCBA is disposed within the cavity of the microphone coupler.

6. The device of claim 1, wherein the acoustic path extends along an axis between the first opening and the second opening, wherein the acoustic path comprises a rectangular shape in a cross-sectional plane that is substantially orthogonal to the axis.

7. The device of claim 1, wherein the first major surface of the body is connected to the first housing and the second major surface of the body is connected to the second housing.

8. The device of claim 1, wherein the microphone coupler is integral with the body.

9. The device of claim 1, wherein the first housing is connected to the acoustic boot and the second housing.

10. The device of claim 1, wherein the second housing is connected to the acoustic boot.

11. The device of claim 1, wherein the device further comprises an enclosure opening defined by the first housing and the second housing.

12. The device of claim 11, wherein the acoustic boot is at least partially disposed within the enclosure opening.

13. An acoustic boot, comprising:
a body comprising a first major surface, a second major surface, and an outer body surface that extends between the first and second major surfaces and connects the first and second major surfaces;
a microphone coupler connected to the body and configured to be disposed within an enclosure; and
an acoustic path defined by the body and that extends between a first opening defined by the outer body surface and a second opening disposed within the microphone coupler and defined by a cavity of the microphone coupler.

14. The acoustic boot of claim 13, wherein the acoustic path extends along an axis between the first opening and the second opening.

15. The acoustic boot of claim 14, wherein the acoustic path comprises a rectangular shape in a cross-sectional plane that is substantially orthogonal to the axis.

16. The acoustic boot of claim 13, wherein the first major surface of the body is substantially parallel to the second major surface of the body.

17. The acoustic boot of claim 13, wherein the microphone coupler is integral with the body.

18. A method of forming an ear-wearable electronic device, comprising:
forming an acoustic boot, wherein forming the acoustic boot comprises:
connecting a microphone coupler to a body of the acoustic boot, wherein the body comprises a first major surface, a second major surface, and an outer body surface that extends between the first and second major surfaces and connects the first and second major surfaces; and
disposing an acoustic path within the body and the microphone coupler, wherein the acoustic path extends between a first opening defined by the outer body surface and a second opening disposed within the microphone coupler and defined by a cavity of the microphone coupler; and
disposing the acoustic boot between a first housing and a second housing to form an enclosure of the ear-wearable electronic device.

19. The method of claim 18, further comprising disposing a microphone at least partially within the cavity of the microphone coupler prior to disposing the acoustic boot between the first housing and the second housing, wherein the microphone is disposed within the enclosure when the acoustic boot is disposed between the first and second housings.

20. The method of claim 18, further comprising:
disposing an electromechanical package within the enclosure, wherein the package comprises the microphone and a flexible printed circuit board assembly (PCBA); and
disposing the microphone at least partially within the cavity of the microphone coupler.
